(19) United States
(12) Patent Application Publication
(10) Pub. No.: US 2024/0281275 A1
(43) Pub. Date: Aug. 22, 2024

(54) COMPUTE EXPRESS LINK (CXL) DRAM BLADE MEMORY

(71) Applicant: Micron Technology, Inc., Boise, ID (US)

(72) Inventor: Satheesh Babu MUTHUPANDI, Boise, ID (US)

(73) Assignee: Micron Technology, Inc., Boise, ID (US)

(21) Appl. No.: 18/433,181

(22) Filed: Feb. 5, 2024

Related U.S. Application Data
(60) Provisional application No. 63/485,828, filed on Feb. 17, 2023.

(51) Int. Cl. G06F 9/455; G06F 13/40

(52) U.S. Cl. CPC G06F 9/45558; G06F 13/4022; G06F 13/409; G06F 2009/45583

(57) ABSTRACT

A system comprises a chassis; a Compute Express Link (CXL) back plane interface mounted within the chassis; a first printed circuit board housed within the chassis and connected to the CXL back plane interface, the first printed circuit board including processing circuitry, switching circuitry and a memory; and a blade server comprising a second printed circuit board housed within the chassis and connected to the CXL back plane interface. The processing circuitry is configured to control the switching circuitry to allocate at least a portion of the memory to the blade server such that a virtual machine provided by the blade server can access the allocated memory through the CXL back plane interface in addition to its own dedicated memory provided by the blade server.

### CROSS-REFERENCE TO RELATED APPLICATION

This application claims benefit to U.S. Provisional Patent Application No. 63/485,828 filed Feb. 17, 2023, the disclosure is incorporated herein by reference in its entirety.

### FIELD OF TECHNOLOGY

The present disclosure relates generally to a memory system, and more particularly to a memory system which provides switching to dynamically allocate additional memory to be accessible to server(s) in a data center.

### BACKGROUND

Memory devices (also referred to as “memory media devices”) are widely used to store information in various electronic devices such as data servers. Various types of memory devices exist, including magnetic hard disks, random access memory (RAM), read-only memory (ROM), dynamic RAM (DRAM), synchronous dynamic RAM (SDRAM), static RAM (SRAM), flash memory, and others. Memory devices may be volatile or non-volatile. Volatile memory cells (e.g., DRAM cells) may lose their programmed states over time unless they are periodically refreshed by an external power source. SRAM memory may maintain their programmed states for the duration of the system being powered on. Non-volatile memory cells may maintain their programmed states for extended periods of time even in the absence of an external power source.

Many data servers for storing information can be housed together in racks with other infrastructure for providing network connectivity, data routing, security, execution of applications and computing, data analytics, and monitoring etc. to form a data center. The data center provides storage of a large amount of amount of data and applications, and also enables shared access to this large amount of data and applications.

The data center may include data servers having high-speed and high density DRAMs formed on printed circuit boards. However, the amount of memory provided by each of the data servers may be exceeded by the memory capacity that is needed. (e.g., the amount of memory required to properly and efficiently execute an application may not be enough). A data server may be limited in its accessible memory because it includes only a limited number of slots for the DRAM and there may be a limited amount of space on the motherboard of the data server and a limited amount of physical space for the data server as a whole.

The amount of memory required for a data center may vary from time to time. For example, a video streaming company may require a 2 terabyte (TB) workload across its data servers on a typical weekend, but the required workload for the same video streaming company across its data servers may be significantly reduced (e.g., by 40% usage) for a typical weekday. The video streaming company may still be paying for the weekend capacity for memory storage even during the weekdays when the required workload is reduced and thus the paid-for memory capacity provided by the data center is being underutilized. Even though the data server has enough computing power, the video streaming company cannot reduce the number of data servers because of memory slot limitations, motherboard real estate and other bottlenecks.

It would therefore be beneficial to be able to dynamically expand the amount of memory (e.g., the amount of memory provided by the DRAM) accessible by a data server on demand to thereby enhance the performance of the data server. It would be further beneficial to dynamically relinquish that expanded amount of memory accessible by the data server when the required workload for the expanded amount of memory has ended such that amount of memory can be scaled to an appropriate level on demand.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an example computing system according to some example embodiments of the present disclosure.

FIG. 2 illustrates the computing system of FIG. 1 including a rack server having a CXL memory plane and blade servers as components according to some example embodiments of the present disclosure.

FIG. 3 illustrates an example functional block diagram logically showing components of the computing system according to some example embodiments of the present disclosure.

FIG. 4 illustrates an example functional block diagram logically showing components of the computing system, including flow paths of information (e.g., data, commands, control signals and/or instructions) between components of the computing system, according to some example embodiments of the present disclosure.

FIG. 5 illustrates the example components of the computing system including a compute express link (CXL) memory plane and the CXL back plane interface according to some example embodiments of the present disclosure.

FIG. 6 illustrates the computing system of FIG. 1 including a top of the rack computing device and an example functional block diagram logically showing components of the top of the rack computing device according to some example embodiments of the present disclosure.

FIGS. 7A-7B illustrate blocks of an example process performed by the computing system according to some example embodiments of the present disclosure.

### DETAILED DESCRIPTION

The present disclosure describes systems, apparatuses, and methods related to a system of memory banks that may be dynamically allocated to one or more host server(s) in a data center so that the host server(s) can expand its accessible memory capacity on demand. The memory that can be dynamically allocated to the host server(s) may be provided by (i) a CXL type 3 memory device, provided on a printed circuit board arranged within the same chassis of the host server(s) in need of or requesting additional memory, such that the allocated memory can accessed via communications conducted through a CXL back plane interface (rather than wired or optical cabling), and/or (ii) a CXL type 3 memory device, including CXL switch fabric housed within a chassis (e.g., a top of the rack chassis) arranged outside of the chassis housing the host server(s) in need of or requesting additional memory, such that the allocated memory can accessed via communications using optical or peripheral component interconnect express (PCIe) wire cabling.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

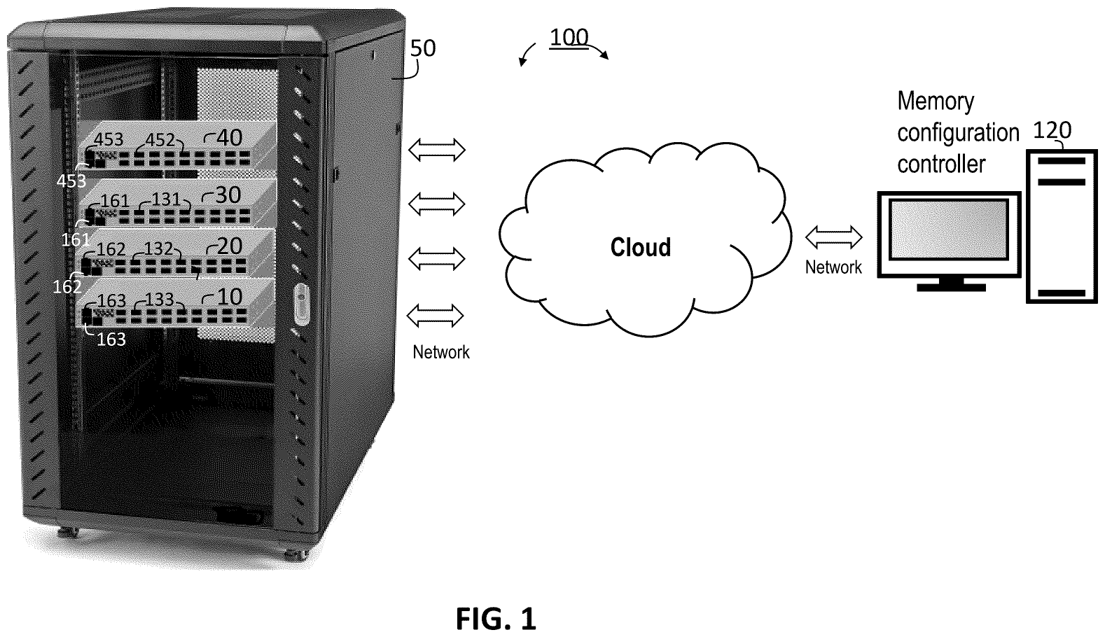

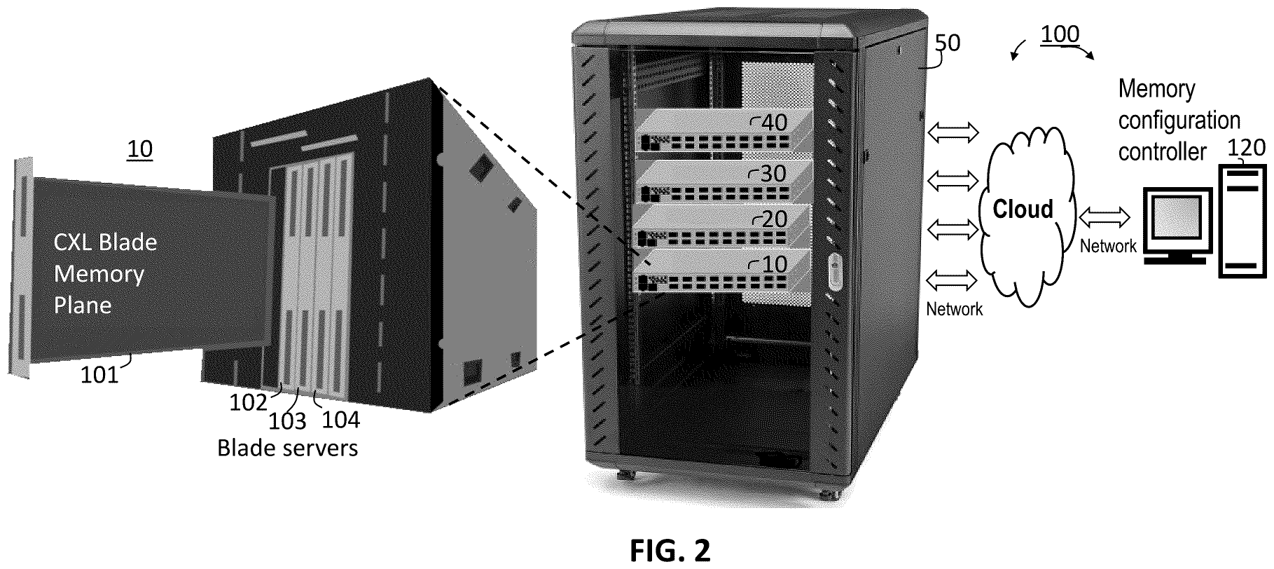

FIG. 1 illustrates an example computing system 100 according to some example embodiments of the present disclosure. FIGS. 2-6 illustrate in more detail components of the example computing system 100 of FIG. 1, including operative logical connections and flow paths of information (e.g., data, commands, control signals and/or instructions) between components of the computing system 100, according to some example embodiments of the present disclosure.

The computing system 100 includes a rack 50, rack servers 10-30, a computing device 40, and a memory configuration controller 120. A chassis of each of the rack servers 10-30 and the computing device 40 is mounted within the rack 50 as shown in FIG. 1.

The memory configuration controller 120 may at least include memory, an operating system, and a central processing unit (CPU) and/or other processing circuitry (e.g., a digital signal processor (DSP) and/or an application specific integrated circuit (ASIC)) including firmware.

The memory configuration controller 120 can communicate information, such as data, commands, control signals and/or instructions, with each of the rack servers 10-30 (including each of the blade servers of each of the rack servers 10-30) and the computing device 40 over the cloud. This includes servers accessible over the Internet and software and databases that are executed on those cloud servers.

The information provided by the memory configuration controller 120 and communicated over the cloud to the rack servers 10-30. In particular, each of the blade servers of the rack servers 10-30, and the computing device 40, may be automatically generated or generated in response to user input at the memory configuration controller 120. While only one memory configuration controller 120 is shown in FIG. 1, it will be understood that additional memory configuration controller(s) 120 may communicate over the cloud with the rack servers 10-30 and the computing device 40. This communication makes it possible for different entities (e.g., different third-party administrators or vendors) to simultaneously communicate over the cloud with the rack servers 10-30 and the computing device 40.

While FIG. 1 shows the memory configuration controller 120 as remotely communicating over the cloud with the rack servers 10-30 (including blade memory planes and blade servers thereof) and the computing device 40. The computing device 40 is mounted within the rack 50. The memory configuration controller 120 may be implemented within one of the rack servers 10-30, such as within a blade server or a blade memory plane of any rack servers 10-30. For example, the instructions performed by the memory configuration controller 120 may be implemented as firmware within any one of the rack servers 10-30, or as software executed by a processing core within any one of the rack servers 10-30.

The network communications between the memory configuration controller 120 and the rack servers 10-30 and the computing device 40 over the cloud may enable a virtual machine (VM) being provided by operation of one of the rack servers 10-30 to obtain access to additional of memory provided by CXL blade memory plane (a component of that rack server 10-30) and/or the computing device 40.

For example, the memory configuration controller 120 may receive a request from a user of the memory configuration controller 120 or a request from a VM being provided by operation of one or more of the rack servers 10-30 for additional memory capacity. In response to this request, the memory configuration controller 120 may determine whether the amount of additional memory requested can be provided by either CXL blade memory plane.

A component from within the same rack servers 10-30 has the blade server(s) needing or requesting additional memory capacity and/or the computing device 40. The computing device 40 is arranged outside of that rack servers 10-30 that include the blade server(s) needing or requesting the additional memory capacity.

If the requested memory can be provided, the memory configuration controller 120 may send instructions to the CXL blade memory plane (a component of that rack server 10-30) and/or the computing device 40. The instructions allot the additional memory to the VM, provided by operation of the blade server needing or requesting additional memory capacity, so the VM can have access to the additionally allotted memory.

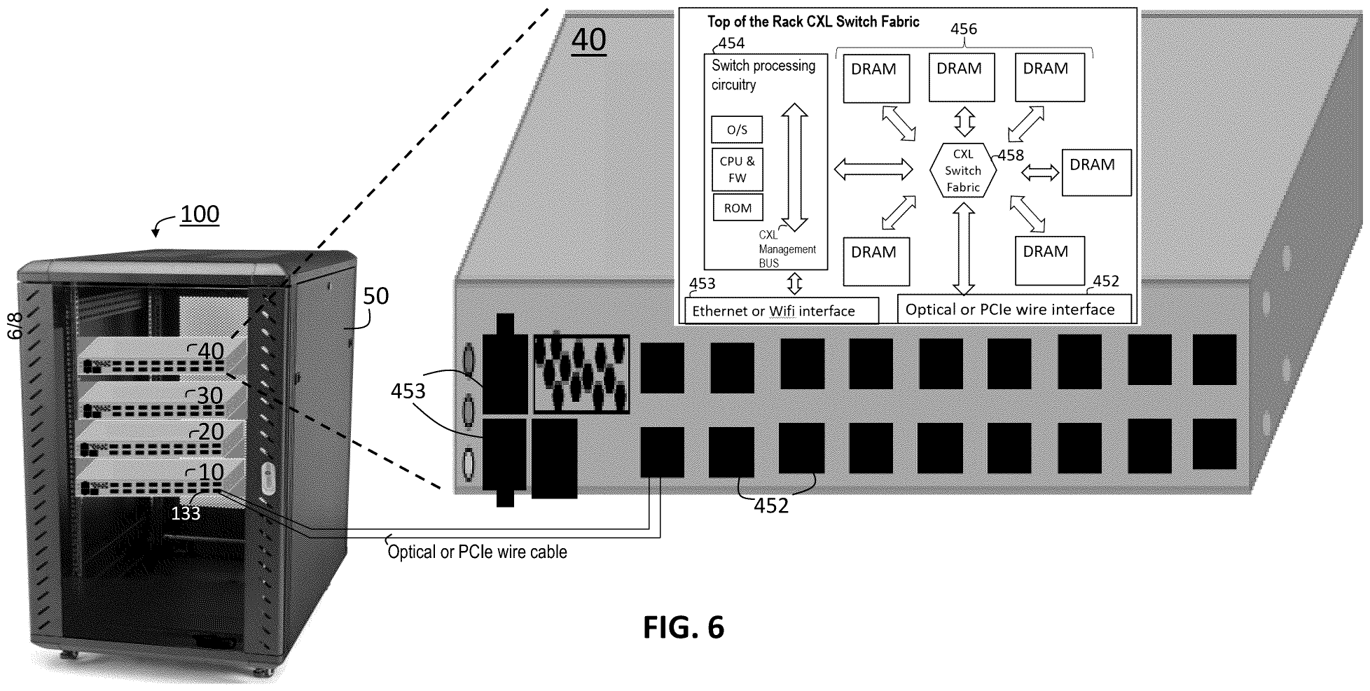

The computing device 40 may be a memory and switching device located at the top of the rack 50. The computing device 40 may be a memory and switching device insofar as memory may be selectively connected or disconnected, such as selectively connecting or disconnecting memory in response to a request. As shown in FIG. 6, the computing device 40 may include optical or PCIe wire interfaces 452, ethernet or wireless fidelity (Wifi) interfaces 453, switch processing circuitry 454, memory 456 comprising DRAM, and switch fabric 458.

Conductivity between each of the rack servers 10-30 and the computing device 40 may be established through a CXL high-speed interconnect cable (wire) or an optical cable (e.g., QSFP-56, QSFP-DD or Octal Small Form Factor Pluggable (OSFP) standards such as QSFP-56+TM, QSFP-DD+™ or OSFP+™ to accommodate PCIe 5.0 CXL transfers) and associated CXL interfaces provided on each of the rack servers 10-30 and the computing device 40 without affecting the bandwidth and latency.

While the rack 50 illustrated in FIG. 1 includes only three rack servers 10-30, additional rack server(s) can be mounted within the empty rack slots. Alternatively, the number of rack server(s) mounted within the rack 50 can be less than that shown in FIG. 1. The computing device 40 is shown as being located on the top of the rack 50 to permit easy access to the cabling that connects the computing device 40 with the rack servers 10-30 within the rack 50. However, the computing device 40 can be located at another location, such as in an intermediate portion of the rack 50, or the bottom of the rack 50.

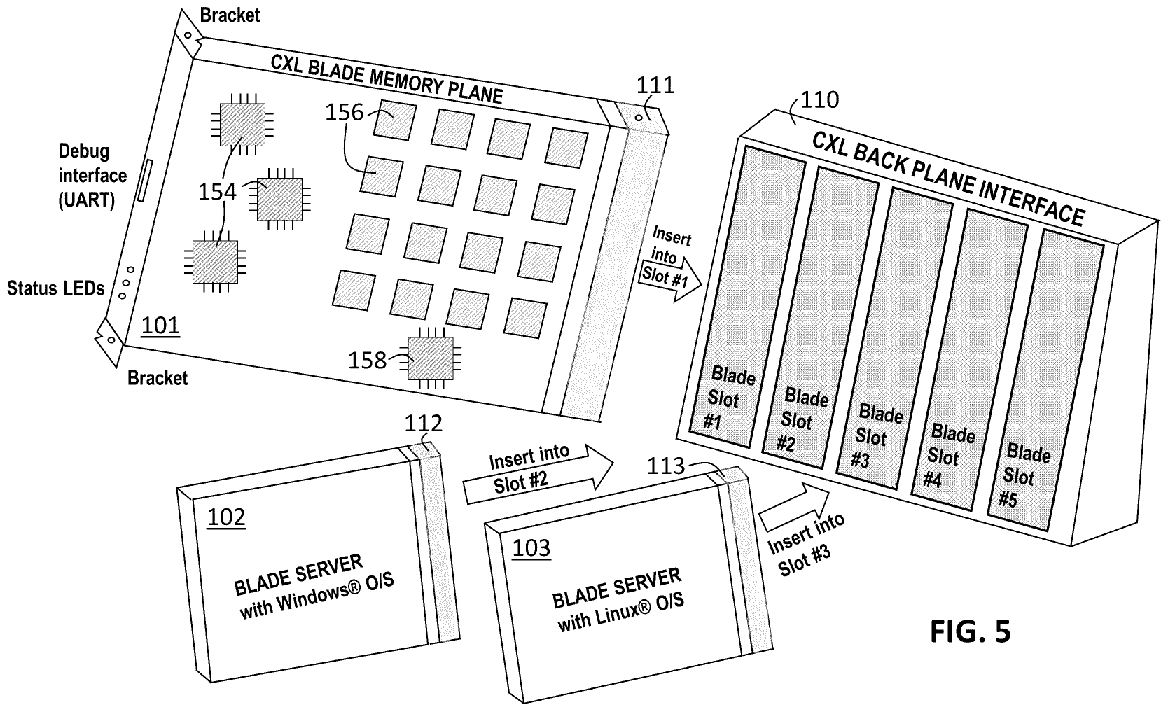

FIG. 2 shows components of one rack server 10, although other rack servers 20, 30 may include the same types of components. The rack server 10 may include a CXL blade memory plane 101 and blade servers 102-104. Each of the CXL blade memory plane 101 and blade servers 102-104 may be housed within a structure that may slide into and out of the rack server 10. A fewer or greater number of blade servers 102-104 can be incorporated into the rack server 10 based upon the space available in the rack server 10 (e.g., additional blade servers that can be inserted into the empty blade slots #4 and #5 in FIG. 5). A chassis of the rack server 10 is mounted within the rack 50 as shown in FIGS. 1-2.

As illustrated in FIGS. 1-5, a chassis of the rack server 10 may house a CXL back plane interface 110 and CXL back plane (PHY) connectors 111-114. The rack server 10 may also include optical or PCIe wire connectors 133 and communications interfaces 163, each of which includes physical ports arranged and exposed at the chassis of the rack server 10.

Each of the CXL back plane connectors 111-114 are connected to the CXL back plane interface 110. Each of the optical or PCIe wire connectors 133 may be connected to a corresponding one of connectors 452 of the computing device 40. Thus, each of the optical or PCIe wire connectors 133 serves as an interface for conducting communications with the computing device 40. The communication occurs through optical or PCIe wire cabling. For example, each of the optical or PCIe wire connectors 133 serves as an interface for conducting communications with the computing device 40. This enables VM(s), provided by operation of the blade server(s) 102-104 of the rack server 10, to access at least a portion memory 456 of the computing device 40.

Similarly, the optical or PCIe wire connectors 131 and 132 of rack servers 30 and 20, respectively, may also be connected to a corresponding one of the connectors 452 of the computing device 40. Thus, each of the optical or wire connectors 131 and 132 serves as an interface for conducting communications with the computing device 40 through optical or PCIe wire cabling. For example, each of the optical or wire connectors 131 and 132 serves as an interface for conducting communications with the computing device 40 through optical or PCIe wire cabling. In this manner, the VM(s) may be provided by operation of the blade server(s) 102-104 of rack server(s) 30 and 20 can access portions of memory 456 of the computing device 40.

The communications interfaces 163 of the rack server 10 may be an ethernet or Wi-Fi interface for conducting communications with the memory configuration controller 120 over the cloud. Similarly, communications interfaces 161 and 162 in the rack servers 30 and 20, respectively, may also be an ethernet or Wi-Fi interface for conducting communications with the memory configuration controller 120 over the cloud. The communications of each of the rack servers through the communications interfaces 161-163 may include data, commands, control signals and/or instructions. This communication enables VM(s), provided by blade server(s) 102-104, to access allotted memory 156 of the CXL blade memory plane 101 and/or allotted memory 556 of the computing device 40.

For example, the blade server 104 can transmit a request for additional memory through the one of the communications interfaces 163 over the cloud to the memory configuration controller 120. As another example, the blade server 104 can transmit data, indicating how much of its own memory 147 is accessible, through one of the communications interfaces 163 over the cloud to the memory configuration controller 120.

The memory configuration controller 120 can determine how much additional memory needs to be allotted to the blade server 104 (beyond its own accessible dedicated memory 147) from the memory 156. The controller 120 may also determine if enough memory 156 of the CXL blade memory plane 101 of the same rack server and/or memory 456 of the computing device 40 is available for the blade server 104. Internet protocol (IP) addresses of the blade servers 102-104 and the memory configuration controller 120 are known to each other to enable Internet communication over the cloud.

The CXL blade memory plane 101 of the rack server 10 may communicate with the memory configuration controller 120 over the cloud. Similarly, CXL blade memory planes of the rack servers 20-30 may also communicate with the memory configuration controller 120 over the cloud. For example, the communications such as data, commands, control signals and/or instructions of the CXL blade memory plane 101 of the rack server 10 may be through one of the communications interfaces 163 or the CXL back plane interface 110 via mutually known IP addresses. These communications enable VM(s) provided by blade server(s) 102-104 to be allotted and have access to memory 156 of the CXL blade memory plane 101.

For example, the memory configuration controller 120 may transmit instructions or requests through one of the communications interfaces 163 or the CXL backplane interface 110. A portion of the memory capacity of memory 156 of the CXL blade memory plane 101 may be allotted to a VM(s) provided by one or more of the blade server(s) 102-104. These instructions received from the memory configuration controller 120 can be processed by the CXL device core 154 to control the CXL switching circuitry 158. This enables a portion of the memory 156 to be appropriately allotted and switched to the VM provided by the blade server 104. Upon reboot of the blade server 104, the VM, provided by that blade server 104, may access the allotted portion of the memory 156 in addition to its own dedicated memory 147.

As another example, the CXL blade memory plane 101 can transmit data, indicating how much of its own memory 156 is free to be allotted to the VM. The memory configuration controller 120 can determine whether enough of the memory 156 is free to satisfy the need or request for additional memory of the VM provided by the blade server 104. If not, the memory configuration controller 120 may conduct further communications with the computing device 40 to determine whether enough of memory 456 is free to satisfy the need for additional memory of the VM provided by the blade server 104.

The CXL back plane connector 111 is connected to both the CXL memory plane 101 and the CXL back plane interface 110. The CXL back plane connectors 112-114 are each connected to the CXL back plane interface 110 and respectively connected to the blade servers 102-104. The CXL back plane interface 110 and the CXL back plane connectors 111-114 may handle the CXL protocol and provide communications at least between the CXL blade memory plane 101 and the blade servers 102-104. In this manner, the device formed by printed circuit board and its mounted or connected components may be regarded as a CXL blade memory plane 101, or CXL memory device controller. Included is a CXL device core 154. The back plane interface 110 may be regarded as the CXL back plane interface 110.

The CXL blade memory plane 101, the CXL back plane connectors 111-114 and the CXL back plane interface 110 can thus be a CXL compliant memory system. CXL is a high-speed CPU-to-device and CPU-to-memory interconnect designed to accelerate next-generation data center performance. CXL technology maintains memory coherency between the CPU memory space and memory on attached devices, which allows resource sharing for higher performance, reduced software stack complexity, and lower overall system cost.

CXL is designed to be an industry open standard interface for high-speed communications, such as accelerators, are increasingly used to complement CPUs in support of emerging applications such as artificial intelligence (AI) and machine learning (ML). CXL technology is built on the PCIe infrastructure, leveraging PCIe physical and electrical interfaces to provide advanced protocol in areas such as I/O protocol, memory protocol (e.g., initially allowing a host to share memory with an accelerator), and coherency interface.

Since the CXL blade memory plane 101 (including the CXL device core 154 and CXL management BUS), CXL back plane connectors 111-114 and the CXL back plane interface 110 are CXL compliant, the processing circuitry including the CXL device core 154 and CXL management bus of the CXL blade memory plane 101 may use CXL protocols to provide management and communications through the CXL back plane interface 110 and CXL back plane connectors 111-114.

The CXL blade memory plane 101 may be operatively connected to one or more of the blade servers 102-104, which can serve as one or more host servers, through the CXL back plane connector 111, the CXL back plane interface 110 and one or more of the respective CXL back plane connectors 112-114. The CXL blade memory plane 101 may thus locally communicate with the blade servers 102-104 with structure such as the CXL back plane interface 110 provided within the chassis forming the rack server 10. These communications may, for example, allow VMs provided by the blade servers 102-104 to access memory provided on the CXL blade memory plane 101 through the CXL back plane interface 110 on demand.

The CXL blade memory plane 101 includes a printed circuit board with electrical components mounted thereon. These mounted electrical components include integrated circuit (IC) chips respectively implementing the CXL device core 154, the memory 156, and the CXL switching circuitry 158. The IC chips also implement the CXL back plane connector 111 connected to the printed circuit board.

The CXL device core 154 of the CXL blade memory plane 101 may at least include memory, an operating system, a CPU, a CX L management BUS and/or other processing circuitry (e.g., a DSP and/or an ASIC). The CXL blade memory plane 101 may also include firmware. These components may communicate with one other via the CXL management BUS or other communications mechanisms including wireless communications mechanisms. The CXL device core 154 can control the transfer of information such as data, commands, control signals and/or instructions with the CXL switching circuitry 158. This control provides the required switching to enable a requested amount of the memory 156, such as a portion or all of it to be allocated to the blade servers 102-104.

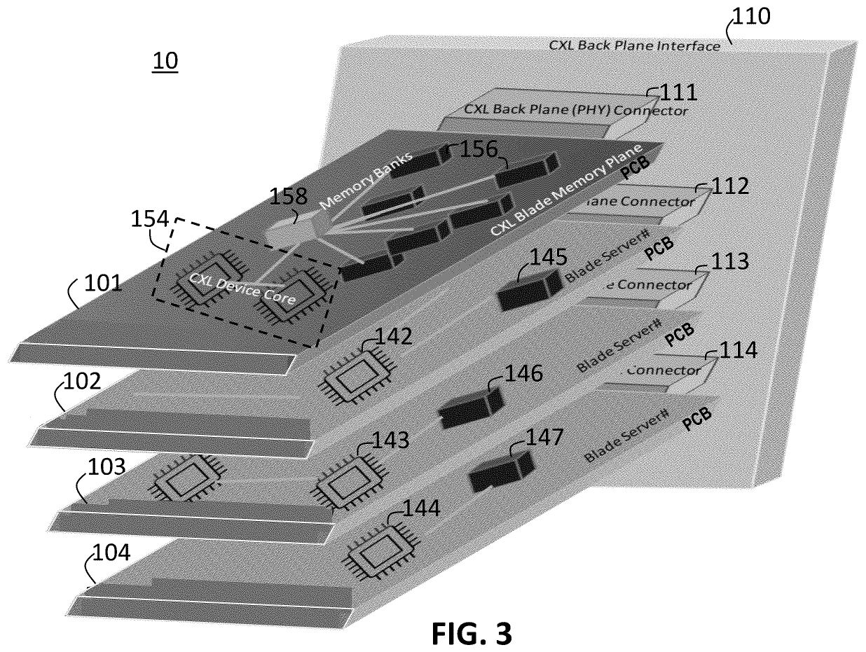

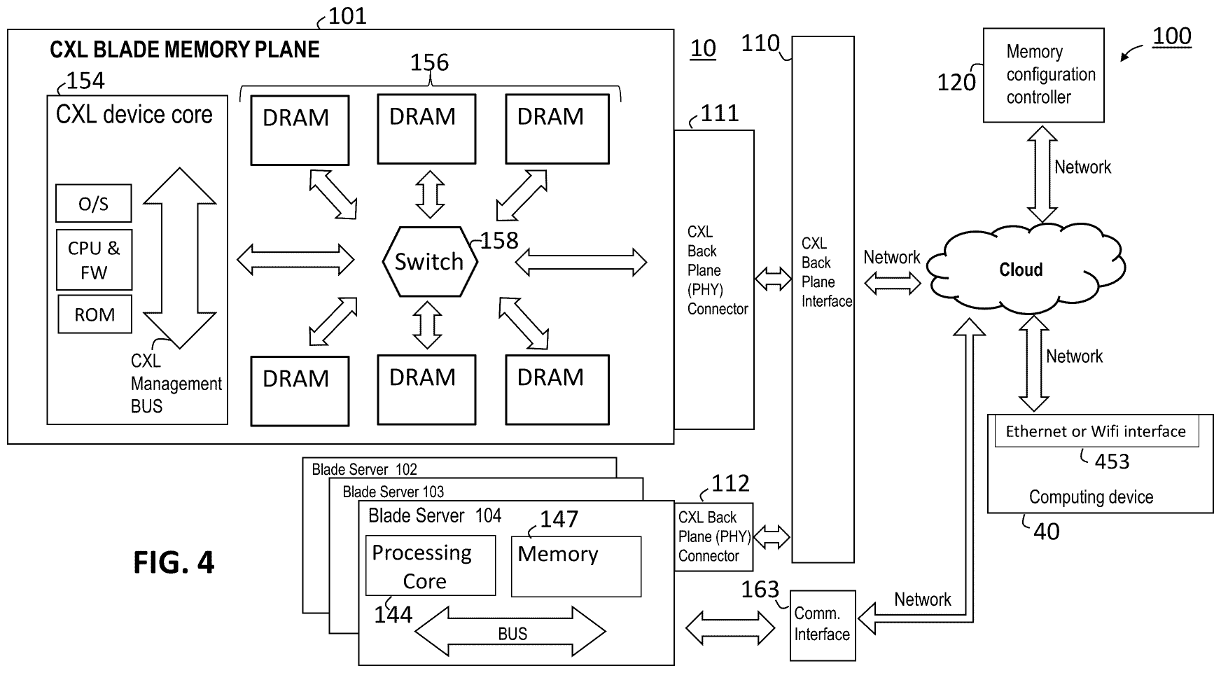

The memory 156 of the CXL blade memory plane 101 may form a CXL type 3 memory device. The memory may be formed by DRAM, but other types of memory may instead be used, such as other types of volatile memory including magnetic hard disks, RAM, ROM, EEPROM, SRAM, magnetoresistive random-access memory (MRAM), etc. While the embodiment illustrated in FIGS. 3-4 shows 6 IC chips forming the memory 156, the number of IC chips, and hence the amount of memory capacity forming the memory 156, can be scaled to a different number of chips (e.g., see FIG. 5 showing additional IC chips). Hence a different amount of memory capacity subject to spatial limitations of the printed circuit board of the CXL blade memory plane 101.

The amount of memory capacity that may be provided by memory 156 of the CXL blade memory plane 101 may be greater than the amount of memory capacity that may be provided by each of the memories 145, 146, 147 of respective blade servers 102, 103 and 104. For example, the amount of memory capacity that may be provided by memory 156 of the CXL blade memory plane 101 may be 100 gigabytes (GB)-4 TB. By contrast, the memory capacity that may be provided by each of the memories 145, 146, 147 of respective blade servers 102, 103 and 104 may be 4 GB-64 GB.

The amount of memory that is accessible by a VM provided by a particular blade server is not limited to the memory capacity of memory 145, 146 or 147. Instead, the amount of memory can be greatly expanded by the much larger memory capacity available through memory 156 of the CXL blade memory plane 101.

The memory 156 can therefore serve to dynamically expand the memory already accessible by each of the blade servers 102-104, such as a memory 145-147 mounted on the respective printed circuit boards of each of the blade servers 102-104. There is direct conductivity between the memory 156 and the blade servers 102-104, CXL back plane interface 110, and the respective CXL back plane connectors 112-114 housed within the same chassis forming the rack server 10. As a result, the communications between the memory 156 and the blade servers 102-104 can be performed with high speed and low latency. That is, a VM provided by execution of a blade server 102-104 can access on demand an allocated portion of memory 156 through this direct connection.

The CXL switching circuitry 158 of the CXL blade memory plane 101 is operatively coupled to the CXL device core 154 and the memory 156. The CXL switching circuitry 158 may operate under the control of the CXL device core 154 and instructions received from the memory configuration controller 120. This operation selectively connects portions of the memory 156 on the CXL blade memory plane 101 with one or more of the blade servers 102-104. This selective connection dynamically expands the memory capacity of the memory 145-147 that is accessible to the one or more of the blade servers 102-104. For example, this memory capacity is accessible to VMs provided by the one or more blade servers 102-104, on demand.

After the need for expanded memory is over, the CXL switching circuitry 158 may operate under the control of the CXL device core 154 and instructions received from the memory configuration controller 120. This operation selectively disconnects portions of the previously allotted memory 156 from one or more of the blade servers 102-104. The selective disconnection dynamically deallocates a portion of the previously allocated memory capacity of memory 156 from the one or more of the blade servers 102-104 on demand.

Even when all of the previously allocated memory 156 has been deallocated, the blade servers 102-104 can still access its own dedicated memory 145-147 provided on the same printed circuit boards of each of the blade servers 102-104 and any memory 456 allocated to each of the blade servers 102-104 from the computing device 40 via optical or PCIe wire interfaces 131-133.

Each of the blade servers 102-104 includes a printed circuit board with electrical components mounted thereon. These mounted electrical components include IC chips implementing the processing core 142, 143 and 144 of blade servers 102, 103 and 104, respectively, and the memory 145, 146, and 147 of blade servers, respectively. Each processing core 142, 143, and 144 is operatively coupled to the memory 145, 146, and 147. Each of the blade servers 102, 103, and 104 also includes the CXL back plane connectors 112, 113, and 114. Each of the CXL back plane connectors 112, 113, and 114 are respectively connected to the printed circuit boards of the blade servers 102, 103 and 104, respectively, and the CXL back plane interface 110.

Each processing core 142, 143, and 144 may include at least memory, an operating system, and a CPU and/or other processing circuitry, as noted above. Each processing core 142, 143, and 144 is operatively coupled to the memory 145, 146 and 147, and the CXL back plane connector 112, 113, and 114, respectively.

Each processing core 142, 143, and 144 can control a transfer of information such as data, commands, control signals and/or instructions with the CXL memory plane 101, particularly the CXL device core 154 of the CXL memory plane 101. As such, the CXL device core 154 operates to control the CXL switching circuitry 158. This control performs the required switching to enable a requested amount of at least a portion of the memory 156 to be allocated to the blade servers 102-104. This control occurs through the CXL back plane interface 111, CXL back plane interface 110, and the CXL back plane connectors 112-114.

For example, each processing core 142, 143, and 144 can transmit a request for additional memory to the memory configuration controller 120 through communication interfaces 163 and the cloud. Blade server 102, 103, and 104 can be allocated at least a portion of the memory 156 of the CXL blade memory plane 101. This process enables access to the portion of the memory 156 allocated to that blade server 102, 103, and 104 through the CXL back plane connector 111, the CXL back plane interface 110, and the appropriate CXL back plane connector 112-114. Each of the processing cores 142, 143, and 144 can control transfer of information such as data, commands, control signals and/or instructions with the computing device 40. In particular, these instructions control the switch processing circuitry 454 and the switch fabric 458 in the chassis at the top of the rack.

This process enables the computing device 40 to operate to control the switch fabric 458 to perform the required switching to enable at least a portion of the memory 456 to be accessible to the blade servers 102, 103, and 104. The control occurs through the optical or PCIe interface 131, 132, and 133. For example, each processing core 142, 143 and 144 can transmit a request for additional memory to the memory configuration controller 120 through communication interfaces 163 and the cloud. This enables the respective blade server 102, 103, and 104 to be allocated at least a portion of the memory 456 and access the allocated portion of the memory 456. The allocation occurs through one of the optical or PCIe wire interfaces 452, the CXL optical or wire cabling, and one of the corresponding optical or PCIe wire interfaces 133 of the rack server 10.

Each blade server 102-104, such as a VM provided by operation of the blade server 102-104, can thus expand its memory capacity provided by its own dedicated memory 145, 146 and 147. This expansion occurs as a result of being dynamically allocated additional memory capacity by the memory 156. For example, the blade server 102 can expand its memory capacity provided by memory 145 by being allocated additional memory capacity provided by a portion of memory 156 through the CXL back plane interface 110 and corresponding CXL back plane connectors 111-112. At the same time, blade server 103 can also expand its memory capacity provided by memory 146 by being allocated additional memory capacity provided by another portion of memory 156.

The additional memory capacity obtained by the blade server(s) 102-104 from memory 156 can be accessed with high speed and efficiency since the memory 156 is local (i.e., within the same chassis forming the rack server 10) and the direct conductivity between the CXL blade memory plane 101. Each of the blade servers 102-104 is established through the CXL backplane 110 (rather than cabling) into which each printed circuit board of the CXL blade memory plane 101, and blade server 112-114, is connected without cabling.

Each blade server 102, 103, and 104 can also expand its memory capacity provided by being dynamically allocated additional memory capacity provided by memory 456. For example, blade server 102 of rack server 20 can dynamically expand its memory capacity provided by memory 456 of the computing device 40. The expansion occurs by being allocated additional memory capacity by a portion of memory 456 of the computing device 40. At the same time, blade server 103 of the rack server 10 can dynamically expand its memory capacity, provided by memory 456 of the computing device 40, by being allocated additional memory capacity provided by another portion of memory 456.

The amount of memory available in each of the CXL blade memory plane 101 and the computing device 40 can be much larger than the memory directly available on each blade server 102-104. For example, a memory capacity of 100 GB to 4 TB or more may be available in each of the CXL blade memory plane 101 and the computing device 40, whereas a memory capacity of 4 GB to 64 GB may be available on each blade server itself.

Each blade server 102-104 can therefore dynamically expand its accessible memory beyond the memory 145-147 directly provided on the printed circuit board of each blade server 102-104. The expansion occurs by being able to access, on demand, at least a portion of memory 156 and/or the memory 456 on the computing device 40 without losing bandwidth or latency. Any portion of the memory 156 or 456 that has not been allocated to a blade server 102-104 of any of the rack servers 10-30 can the allocated to any blade server 102-104 of any of the rack servers 10-30.

If a blade server 102-104 of any of the rack servers 10-30 needs additional memory, the memory configuration controller 120 may provide operation such that that blade server 102-104 first looks to obtain that memory 156 locally within that same rack server 10-30, wherein that memory 156 is accessible through the CXL back plane interface 110 connected to that blade server 102-104 needing additional memory. If that memory 156 cannot meet the demand, the memory configuration controller 120 can provide further operation to look to obtain that needed memory capacity from memory 456. The memory 456 is accessible to the blade server 102-104 through one of the optical or wire interfaces 452, the optical or wire cabling, and the connected one of the optical or wire interfaces 131-133.

The blade servers 102-103 can operate using the same or different operating systems. For example, blade server 102 can operate using a Windows® operating system, whereas the blade server 103 of the same rack server can operate under a Linux® operating system, as show in FIG. 5. The rack server 10 including these blade servers 102-103 operating under different operating systems can thus constitute a heterogeneous system, and thereby increase its flexibility and capabilities. Each of the blade servers 102 and 103 operating using different operating systems may alternatively be arranged in different rack servers. For example, the blade server 102, operating using a Windows® operating system, can be in the rack server 10. The blade server 103 operating using a Linux® operating system can be in the [different] rack server 20.

The computing device 40 may constitute a memory and switching device (a CXL memory and switching device 40). The computing device 40 may be configured to selectively connect or disconnect memory 456 to other devices, such as any of the blade servers 102-104 of any of the rack servers 10-30. The connect/disconnect occurs through operation of the switch fabric 458 as controlled by the switch processing circuitry 454 and instructions provided by the memory configuration controller 120. The switch processing circuitry 454 may at least include memory, an operating system, and/or firmware, each of which may communicate with one another via a bus or other communications mechanisms including wireless communications mechanisms.

The switch processing circuitry 454 can control a transfer of information such as data, commands, control signals and/or instructions with the switch fabric 458. This provides the required switching to enable a requested amount of the memory 456 to be allocated to the blade servers 102-104. The allocation occurs through optical or wire cabling that connects one of the optical or wire interfaces 452 and a corresponding one of the optical or wire interfaces 131-133. For example, FIG. 6 shows an optical or PCIe wire cable connecting one of the optical or wire interfaces 452 of the computing device 40 and a corresponding one of the optical or PCIe wire interfaces 133 of the rack server 10.

It is to be understood that any of the ports forming the optical or wire interface 452 of the computing device 40 can be connected to any of the ports of the optical or PCIe wire interfaces 131-133 of any of the rack servers 10-30. For example, the switch processing circuitry 454 may respond to a request or instruction wired or wirelessly received from the memory configuration controller 120 to control the switch fabric 458. Portions of the memory 456 can be selectively connected and disconnected to any of the blade server(s) 102-104 in any of the rack server(s) 10-30 arranged outside of the computing device 40.

In accordance with the request or instructions received from the memory configuration controller 120, the switch processing circuitry 454 can thus control or manage the switch fabric 458 to selectively allocate portions of memory 456 to any rack server 10-30. Portions of memory 456 can be selectively allocated to a VM provided by any blade server 102-104 of any of the rack servers 10-30. A VM provided by one or more of blade servers 102-104 can access the memory 145-147 on that blade server 102-104, respectively.

Additionally, the VM can also access, through the CXL optical or wire cabling and corresponding optical or PCIe interfaces 131-133 and 452, extra memory capacity. The extra capacity is provided by a portion of the memory 456 selectively connected to that blade server 102-104 by the switch fabric 458 under the control of the switch processing circuitry 454. The blade servers 102-104, that have been allotted additional memory from memory 456, may be located within the same or different rack servers 10-30.

The memory 456 of the computing device 40 may form a CXL type 3 memory device. The memory 456 may be formed by DRAM, but other types of memory may instead be used, such as those noted above. The example embodiment illustrated in FIG. 6 shows 6 IC chips forming the memory 456, the number of IC chips, and hence the amount of memory capacity forming the memory 456. The number of IC chips can be scaled to a different number of chips and a different amount of memory capacity. This is subject to spatial or other limitations of the computing device 40.

The memory 456 can dynamically expand the memory that is already accessible by each of the blade servers 102-104 of the rack servers 10-30, such as the memory 145-147. The control communications necessary to dynamically expand the memory accessible by one or more of the blade servers 102-104.

The switch fabric 458 of the computing device 40 is operatively coupled to the switch processing circuitry 454 and the memory 456. The switch fabric 458 operates under the control of the switch processing circuitry 454 to selectively connect portions of the memory 456 with one or more of the blade servers 102-104. This can dynamically expand the capacity of the memory accessible to the blade servers 102-104 in response to a request from the CXL blade memory plane 101 or blade server 102-104.

After the need for the expanded memory capacity of memory 456 is over, the switch fabric 458 may operate under the control of the switch processing circuitry 454 and instructions received from the memory configuration controller 120. The switch fabric selectively disconnects portions of the previously allotted memory 456 from one or more of the blade servers 102-104. The selective disconnection dynamically deallocates a portion of the previously allocated memory capacity from the one or more of the blade servers 102-104. When all of the previously allocated memory 456 has been deallocated, the blade servers 102-104 can access its own dedicated memory 145-147, such as that provided on the printed circuit boards of each of the blade servers 102-104.

The optical or PCIe wire interface 452, the switch processing circuitry 454, and the switch fabric 458 can handle the CXL protocols and provide communications between at least the CXL blade memory plane and the blade servers 102-104. As such, the computing device 40 may be regarded as a CXL switch and memory device and the optical or wire interface 452, switch processing circuitry 454 and switch fabric 458 may be regarded as the CXL optical or wire interface 452, the CXL switch processing circuitry 454, and CXL switch fabric 458.

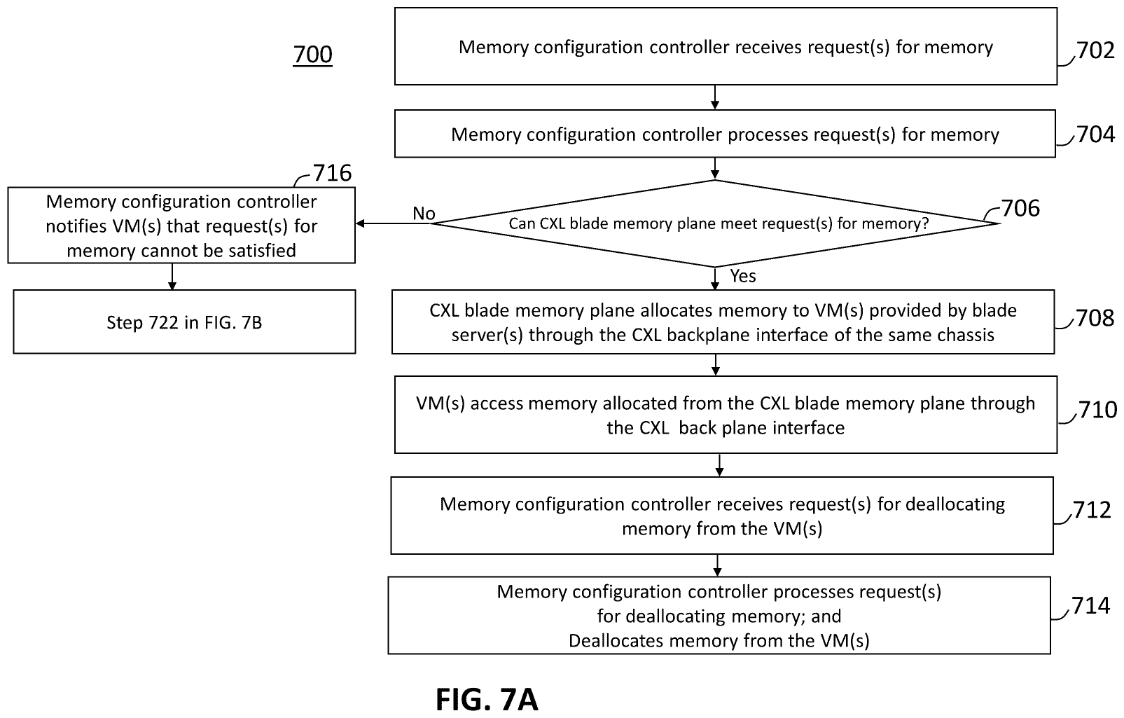

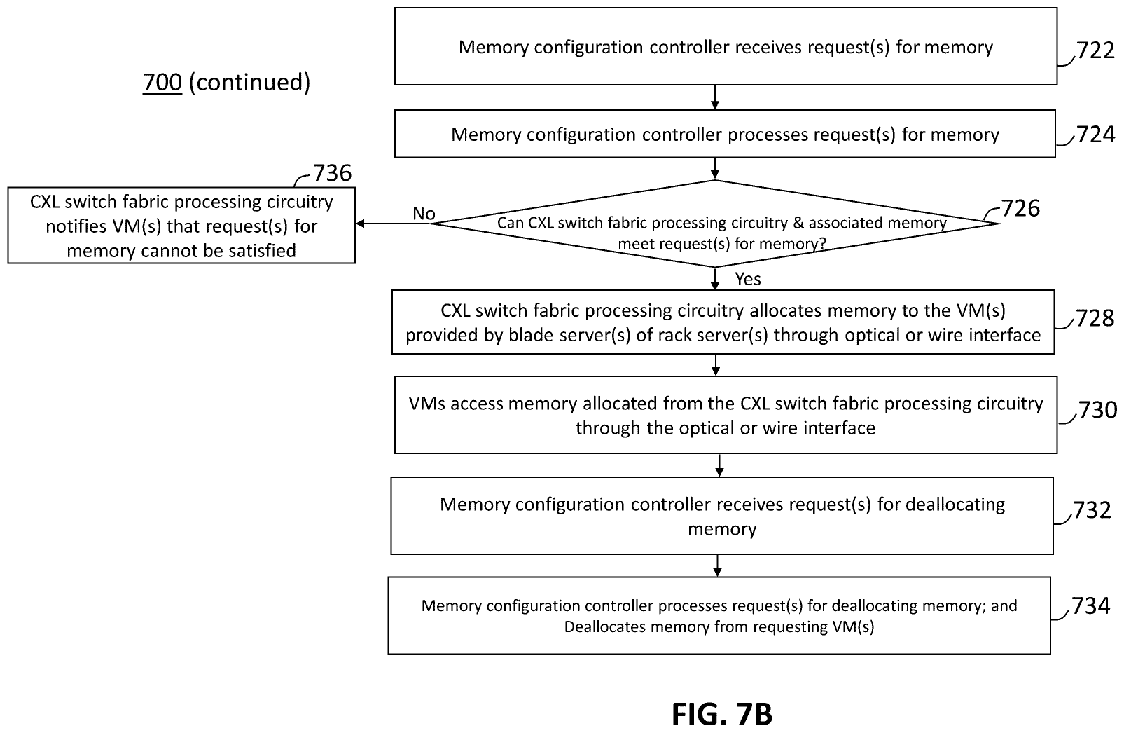

FIGS. 7A-7B illustrate operations of an example process 700 performed by the computing system 100 according to the embodiments. In block 702 of the process 700, the memory configuration controller 120 receives at least one request for additional memory. This request for additional memory essentially indicates that the memory capacity of a memory that may be accessed by a host server be expanded. The request may be received through an input interface provided on the memory configuration controller 120 and/or received through communications from any one of the blade servers 102-104 of any one the rack servers 10-30.

Requests received through the input interface provided on the memory configuration controller 120 may be from a human user input or may be generated from another computer. Requests received through communications from any one of the blade servers 102-104 of any one of the rack servers 10-30 may be provided by network communications transmitted through the communications interfaces 163 or CXL backplane interface 110 over the cloud to the memory configuration controller 120. The request may designate how much memory capacity is required. For example, a first request may indicate that 100 GB of memory is needed for a VM being provided by one blade server 102, and a second request may indicate that 2 TB is needed for a VM being provided by another blade server 103.

In block 704, the memory configuration controller 120 processes the request(s) for additional memory. In particular, the memory configuration controller 120 determines if the CXL memory plane 101 can satisfy the request(s) for memory. This may involve the memory configuration controller 120 communicating with the CXL blade memory plane 101 to determine the amount of memory 156 available for allocation to the blade server 102-104 needing memory. If the memory request does not indicate the amount of additional memory needed, the memory configuration controller 120 may also communicate with the blade server 102-104 to determine this amount.

If the memory configuration controller 120 determines that the amount of available memory capacity of memory 156 is sufficient to cover the amount of memory needed, the memory configuration controller 120 determines that the request for memory can be satisfied. For example, if the memory configuration controller 120 determines that the amount of available capacity of memory 156 is 4 TB, and the first and second requests for memory are for 100 GB and 2 TB, respectively, the memory configuration controller 120 determines that the first and second requests can be satisfied.

If, however, the memory configuration controller 120 determines that the amount of available capacity of memory 156 is insufficient, the memory configuration controller 120 will determine the first and second requests cannot be satisfied. Alternatively, the memory configuration controller 120 may determine that only one of the requests can be satisfied.

If the memory configuration controller 120 determines that the request(s) for additional memory can be satisfied (block 706), the CXL blade memory plane 101 will, per the request(s), allocate memory to the VM(s) provided by the blade server(s) 102-104 in block 708. In particular, the memory configuration controller 120 can communicate an instruction over the cloud and through either one of the communications interfaces 163 or the CXL backplane interface 110 to the CXL blade memory plane 101 to allocate at least a portion of memory 156 to the VM(s) provided by the blade server(s) 102-104 in block 708.

The CXL device core 154 may process this instruction received from the memory configuration controller 120. In particular, the CXL device core 154 will provide data, commands and instructions to the CXL switching circuitry 158 to control the switching to selectively connect portion(s) of the memory 156 to the blade server(s) 102-104 through the CXL back plane connector 111. The CXL device core 154 thus allocates at least a portion of the capacity of memory 156 to the blade servers 102-104 to satisfy the need(s) or request(s) for additional memory. In the foregoing example, the CXL device core 154 may allocate 100 GB of its 4 TB memory capacity of memory 156 to blade server 102 to satisfy the first request for memory. Additionally, the CXL device core 154 may also allocate 1 TB of its 4 TB to blade server 103 to satisfy the second request for memory.

In block 710, the VMs provided by the blade servers 102-104 can access the memory 156 allocated from the CXL blade memory plane 101 in block 708. The VMs provided by each of the blade servers 102-104 can also access their own dedicated memory 145-147. The VMs can thus access their own dedicated memory and additionally access the allocated memory 156. The additional allocated memory 156 may become available to each of the VMs when each reboots.

In the foregoing example, the blade server 102 may, upon reboot, access 100 GB of additional memory capacity from the memory 156 through CXL backplane connectors 111-112 and the CXL backplane interface 110. This accessed memory results from the satisfied first request for memory and the blade server 102 may also access its own dedicated memory 145. The blade server 103 may, upon reboot, access 2 TB of additional memory capacity from memory 156 through CXL backplane connectors 111 and 113 and the CXL backplane interface 110. This accessed memory results the satisfied second request for memory and may also access its own dedicated memory 146.

The memory that can be accessed by the VM(s) provided by each of the blade server(s) 102-104 can therefore be greatly and dynamically expanded to include the allocated portion of memory 156 on demand to meet changing load requirements. Because CXL blade memory plane 101 is directly connected to the blade servers 102-104 through the CXL back plane interface 110 (rather than through cabling), all communications between CXL blade memory plane 101 and the blade servers 102-104, including the blade server(s) 102-104 accessing the allocated portion(s) of the memory 156, can be conducted with high speed and low latency and without losing bandwidth. The available memory bandwidth can therefore be greatly increased. The amount of available memory can be increased on demand and in response to changing memory load requirements. Accordingly, the performance of the computing system 100 can be increased.

In blocks 712-714, the memory configuration controller 120 may receive and process request(s) for deallocating the memory 156 that was previously allocated to one or more of the blade servers 102-104. The deallocation may be complete or partial as requested. The request for deallocation of the previously allocated memory may be received through the input interface provided on the memory configuration controller 120 externally from a user or another computer.

Alternatively, the request for deallocation can be received over the cloud from one of the blade servers 102-104 through one of the communications interfaces 163 or the CXL backplane interface 110. After the previously allocated memory 156 has been released or deallocated, that memory is free to then be reallocated to the same or another blade server in need of additional memory. The amount of allocated memory capacity of memory 156 to a blade server 102-104 can thus be increased or decreased based upon changing memory load requirements.

After the previously allocated memory 156 has been completely released from the blade server 102-104, the particular blade server 102-104 can still access the dedicated memory 145-147. Other request(s) can be made for the blade server(s) in need of memory to reallocate memory 156 of the CXL blade memory plane 101 if additional memory is again required by any VM being provided by that blade server 102-104.

Returning to block 706, the memory configuration controller 120 may determine that the CXL blade memory plane 101 cannot meet the request for additional memory. If it cannot, the memory configuration controller 120 notifies the VM provided by the blade servers 102-104 in block 716 the request for memory cannot be met. Correspondingly, a request for memory to satisfy this unmet request can be sent to the computing device 40 to determine whether the memory 456 can satisfy this request unmet by the CXL blade memory plane 101.

In other words, if the request for additional memory for a VM provided by a blade server 102-104 cannot be locally met by a CXL blade memory plane 101 within that same rack server 10, a request for additional memory for the VM can be made to the computing device 40. The computing device 40 is arranged outside of the rack server 10 but within the same rack 50. This request for additional memory determines whether the memory 456 of the computing device 40 can meet this request.

In block 722, the memory configuration controller 120 receives at least one request for additional memory. This request for additional memory may be received through the input interface provided on the memory configuration controller 120 over the communications interfaces 163 or the CXL backplane interface 110. Each request may designate how much memory capacity is required. These requests can be for blade servers 102-104 of the same or different rack servers 10-30.

In block 724, the memory configuration controller 120 processes the request(s) for additional memory. In particular, the memory configuration controller 120 may determine if the computing device 40, including the capacity of the memory 456, can satisfy the request(s) for additional memory. This may involve the memory configuration controller 120 communicating with the CXL switch processing circuitry 454 to determine the amount of memory 456 needed by the blade server 102-104, when the original request devoid of the amount of memory needed. If the memory configuration controller 120 determines that the amount of available memory capacity of memory 456 is sufficient, the memory configuration controller 120 will determine the requests can be met.

The memory configuration controller 120 may determine the request(s) for additional memory can be satisfied (block 726) by the computing device 40 including the CXL switch fabric 458 and memory 456. If so, memory capacity of the memory 456 will allocate to the VM(s) provided by the blade server(s) 102-104 of the same or different rack servers 10-30 in block 728. Accordingly, the CXL switch processing circuitry 454 will provide data, commands and instructions to the CXL switch fabric 458 to selectively connect portions of the memory 456 to the blade servers 102-104 to satisfy the request(s) for additional memory.

In block 730, the VM(s) provided by the blade server(s) 102-104 can access the memory 456 allocated from the computing device 40 in block 728. The VMs provided by each of the blade servers 102-104 can also access their own dedicated memory 145-147. Thus, the VMs can access their own dedicated memory 145-147 though the internal wiring provided on the printed circuit board. The VMs may also access the allocated memory 456 through the optical or wire cabling that connects interface 452 and the optical or PCIe wire interface(s) 131-133 of the rack server(s).

The additional allocated memory 456 may become available to each of the VMs when each of these VMs reboots. In an example, the blade server 102, upon reboot, may access 100 GB of additional memory capacity from memory 456 (and may access its own memory 145) responsive to the satisfied first memory request. The blade server 103, upon reboot, may access 2 TB of additional memory capacity from memory 456 (and may access its own memory 146) responsive to the satisfied second memory request.

The memory that can be accessed by the VM(s) provided by the blade server(s) 102-104 of the same or different rack servers 10-30 can therefore be greatly and dynamically expanded to include the allocated portion of memory 456 on demand to meet changing load requirements. Because the computing device 40 is directly connected to the blade servers 102-104 via high-speed optical or PCIe wire cabling within the same rack 50, accessing the allocated portions of the memory 456 can be conducted with high speed and low latency and without losing bandwidth.

The available memory bandwidth for a VM can therefore be greatly increased as it is not limited to only the dedicated memory provided by the blade server 102-104 providing the VM. The amount of available memory can be increased on demand and in response to changing memory load requirements. Accordingly, the performance of the computing system 100 can be increased.

In blocks 732-734, the memory configuration controller 120 may receive and process requests for deallocating the memory 456 previously allocated to one or more of the blade servers 102-104. The deallocation may be complete or partial as requested. After the previously allocated memory 456 has been released or deallocated, that memory is free to be allocated to the same or another blade server. The amount of allocated memory to a blade server 102-104 can thus be increased or decreased based upon changing memory load requirements. Even after the previously allocated memory 456 has been completely released from the blade server 102-104, the particular blade server 102-104 can still access its own dedicated memory 145-147.

Returning to block 726, if the memory configuration controller 120 determines that computing device 40 cannot meet the request for memory, the memory configuration controller 120 provides notification to the VM provided by the blade server 102-104 in block 736 that the request for memory cannot be met by the computing device 40.

Alternatively, modifications to the process 700 above can be made. For example, a VM provided by any blade server 102-104 can obtain and access memory capacity from both memory 156 of the CXL blade memory plane 101 of the same rack server and 456 and the memory 456 of the computing device 40. This capability is a function of appropriate requests being received and processed by the memory configuration controller 120.

In another alternative example embodiment, a request for additional memory for a VM provided by any blade server 102-104 can be made to the computing device 40 without previously checking whether the requested memory could be provided by the CXL blade memory plane 101 in the same server rack. That is, there is no requirement that a request for expanded memory be denied by the CXL blade memory plane 101 before the request for expanded memory is made to the computing device 40. The process illustrated in FIG. 7B could, therefore, be performed without previously performing the process illustrated in FIG. 7A.

As used herein, the term “substantially” intends that the characteristic needs not be absolute, but is close enough so as to achieve the advantages of the characteristic. For example, “substantially simultaneously” is not limited to operations that are performed absolutely simultaneously and can include timings that are intended to be simultaneous but due to manufacturing limitations may not be precisely simultaneously.

The functions of the computing system 100 may be implemented by processing circuitry such as hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims.

For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Furthermore, the “processing circuitry” and/or various illustrative blocks and components described in connection with the disclosure herein (including the claims) may be implemented or performed with a general-purpose processor, a DSP, an ASIC, a field programmable gate array (FPGA) or other programmable logic device, discrete gate or transistor logic, discrete hardware components, or any combination thereof designed to perform the functions described herein.

A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “transmit”, “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components.

At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components.

In some examples, the flow of signals between the connected components may be interrupted for a time, for example, using one or more intermediate components such as switches or transistors. The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

Additionally, the terms “directly in response to” or “in direct response to” may refer to one condition or action occurring as a direct result of a previous condition or action. In some examples, a first condition or action may be performed, and a second condition or action may occur directly, as a result of the previous condition or action occurring independent of whether other conditions or actions occur.

The devices discussed herein, including a memory array or memory device, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium.

For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A system comprising:
a chassis;
a Compute Express Link (CXL) back plane interface mounted within the chassis;
a first printed circuit board housed within the chassis and connected to the CXL back plane interface, the first printed circuit board including processing circuitry, switching circuitry and a memory; and
a first blade server comprising a second printed circuit board housed within the chassis and connected to the CXL back plane interface;
wherein the processing circuitry is configured to control the switching circuitry to allocate at least a portion of the memory to the first blade server through the CXL back plane interface.

2. The system of claim 1, wherein the processing circuitry is further configured to control the switching circuitry to deallocate the at least a portion of the memory from the first blade server.

3. The system of claim 1, wherein the first blade server is configured to provide a virtual machine;
wherein the virtual machine (i) is provided by the first blade server and (ii) is configured to access additional memory arranged outside of the chassis.

4. The system of claim 1, wherein the second printed circuit board of the first blade server includes a memory; and
wherein a memory capacity of the memory of the first printed circuit board is larger than a memory capacity of the memory of the second printed circuit board.

5. The system of claim 1, further comprising an optical or wire interface configured to be operatively coupled with switch fabric processing circuitry arranged outside of the chassis.

6. The system of claim 1, further comprising an optical or wire interface configured to access additional memory arranged outside of the chassis.

7. The system of claim 1, further comprising:
a communications interface configured to receive information from a remote source, the information indicating an amount of the at least a portion of the memory that is to be allotted to the first blade.

8. The system of claim 1, further comprising a second blade server, the second blade server comprising a third printed circuit board housed within the chassis and connected to the CXL back plane interface;
wherein the processing circuitry is configured to control the switching circuitry to allocate another portion of the memory to the second blade server through the CXL back plane interface.

9. The system of claim 8, wherein the first blade server is configured to operate using a first operating system, the second blade server is configured to operate using a second operating system, and the first operating system is different from the second operating system.

10. A method of operating a system including a chassis, a Compute Express Link (CXL) back plane interface housed within the chassis; a first printed circuit board housed within the chassis and connected to the CXL back plane interface, the first printed circuit board including processing circuitry, switching circuitry and a memory, and a first blade server comprising a second printed circuit board housed within the chassis and connected to the CXL back plane interface, the method comprising
receiving a first request,
controlling the switching circuitry in response to the first request to allocate at least a portion of the memory to the first blade server through the CXL back plane interface;
receiving a second request; and
controlling the switching circuitry in response to the second request to deallocate the at least a portion of the memory from the first blade server.

11. The method of claim 10, further comprising accessing, by a virtual machine provided by the first blade server, additional memory arranged outside of the chassis.

12. The method of claim 10, further comprising conducting communication with switch fabric processing circuitry arranged outside of the chassis; and
accessing additional memory arranged outside of the chassis through an optical or wire interface.

13. The method of claim 10, further comprising providing a second blade server, the second blade server comprising a third printed circuit board housed within the chassis and connected to the CXL back plane interface; and
controlling the switching circuitry to allocate another portion of the memory to the second blade server through the CXL back plane interface.

14. The method of claim 13, further comprising operating the first blade server using a first operating system and operating the second blade server using a second operating system, the first operating system is different from the second operating system.

15. A device comprising:
a printed circuit board;
a Compute Express Link (CXL) back plane connector connected to the printed circuit board;
switching circuitry mounted on the printed circuit board;
processing circuitry mounted on the printed circuit board and operatively coupled to the switching circuitry; and
memory operatively mounted on the printed circuit board and coupled to the switching circuitry;
wherein the processing circuitry is configured to control the switching circuitry to allocate at least a portion of the memory to a blade server through the CXL back plane connector.

16. The device of claim 15, wherein the processing circuitry is further configured to deallocate the at least a portion of the memory from the blade server.

17. The device of claim 15, wherein a memory capacity of the memory of the printed circuit board is larger than a memory capacity of a memory of the blade server.

18. The device of claim 17, wherein processing circuitry is further configured to receive and process information indicating an amount of the memory that is to be allotted to the blade server.

19. The device of claim 15, wherein the processing circuitry is configured to control the switching circuitry to allocate another portion of the memory to another blade server through the CXL back plane connector.

20. The device of claim 19, wherein the processing circuitry is further configured to control the switching circuitry to allocate the at least a portion of the memory to the blade server using a first operating system; and
control the switching circuitry to allocate another portion of the memory to another blade server configured to operate using a second operating system;
wherein the first operating system is different from the second operating system.
